(19) United States
(12) Patent Application Publication
(10) Pub. No.: US 2007/0204285 A1
(43) Pub. Date: Aug. 30, 2007

(54) Method for integrated media monitoring, purchase, and display

(76) Inventor: Gert Hercules Louw, New York, NY (US)

Correspondence Address: Ward & Olivo, Suite 400, 382 Springfield Avenue, Summit, NJ, 07901, US

(21) Appl. No.: 11/364,836

(22) Filed: Feb. 28, 2006

(51) Int. Cl. H04N 7/16; H04H 9/00

(52) U.S. Cl. 725/14; 725/9

(57) ABSTRACT

A method for integrated media monitoring is disclosed, wherein multiple forms of media are monitored and searched according to user defined criteria. The method may be used by a business to understand how a product or service is being received by the general public. Monitoring includes analysis of closed captioning data and human monitoring so as to provide a business with a full understanding of advertising and editorial effectiveness. A user provides media search parameters via a network, and a near real-time hit list is produced and presented to the requesting user. Options for previewing and purchasing matching media segments are presented, along with corresponding reports and coverage analyses. Previewing can occur via a streamed video format, whereas purchasing allows for high quality video download. Reports include information about how the product was conveyed, audience watching, and value to the business. Reports can be created by the system or by the user, formatted for presentation, purchased, and downloaded.

### FIELD OF THE INVENTION

The present invention relates generally to all forms of disseminated media and, more particularly, to a method for integrated media monitoring, purchase, and display over a network, such as the Internet.

### BACKGROUND OF THE INVENTION

Companies spend significant sums of money each year to advertise products and services through various forms of media. Public relations, and advertising in particular allows companies to gain a competitive edge in the marketplace, increase company or product exposure, attract potential customers, and develop brand interest. Competitors may also utilize advertising for strategic counter-campaigns, brand repositioning, and other tactical marketing maneuvers. Since advertising is such an important factor in brand reputation, product and service recognition, and overall performance of a business, it is important for a company to effectively manage and monitor the effectiveness of its advertising.

In addition to advertising, companies also expend significant resources on editorial and news coverage. Editorial media, like advertising, has important financial consequences for businesses offering products or services to consumers. Editorial media, such as news coverage on a product introduction or enhancement, a service introduction or enhancement, product recall information, informative press releases, a market review article, a media segment, etc., can drastically influence consumer opinion and brand recognition.

Thus, a comprehensive understanding of both advertising and editorial coverage across all forms of disseminated media is crucial to the success of any business. However, historically, media monitoring has been severely limited. For example, many monitoring services and systems are limited to just one form of media coverage, such as television broadcasts. Often, these systems yield a distorted, incomplete, and/or biased view of a company's public image, failing to produce a holistic picture of the overall well-being of a business.

Traditional systems are also generally limited to only electronic forms of monitoring. Existing electronic broadcast monitoring systems fall into three general categories. The first category requires an identification signal to be inserted into the broadcast material. For example, one current system in the art inserts a modulated code onto an audio frequency sub-carrier. The code is then interpreted by the system to retrieve programming information. Other systems in the art modulate a code onto a line in the vertical interval of the television broadcast signal. The code is then extracted by the system and interpreted to retrieve broadcast information. All systems in this category require the cooperation and participation of the broadcaster. Thus, these systems are inherently limited by the broadcaster's acceptance of the system and intent in supporting a commercial system that monitors broadcasts. These systems also require an allocation of some signal bandwidth (either audio or video) in the television broadcast signal. It is readily known that many revenue-conscious broadcasters would rather utilize this bandwidth for the generation of proceeds. In addition, the FCC has not reserved or protected any bandwidth for the purpose of program identification via this type of signal augmentation. Without this regulation, these systems have no place in the marketplace and no viable function.

The second category of electronic broadcast monitoring analyzes the program content of the broadcast signal to identify the broadcast signal. For example, various video and audio signals of a television broadcast may be analyzed to determine program content. Features of the broadcast signal are parsed and compared to a database containing features previously extracted from known program segments. These systems require large amounts of information and signal processing and advanced analysis techniques. For example, a system of this type typically require a continuous Fourier transformation of the broadcast signal being monitored. Powerful, dedicated signal processors and immense amounts of comparison data are needed in this type of analysis. However, only limited amounts and types of information can be extracted.

Finally, the third category of broadcast monitoring involves the use of FCC mandated closed captioning (CC) services. In countries that utilize the National Television Systems Committee (NTSC) television system (like the U.S. and Canada) analog television broadcasts are encoded with transcribed audio as native 608 (CEA-608) closed captions. These captions are carried on the two fields of Line 21 of the vertical blanking interval—a part of the television picture that sits just above the visible portion and is usually unseen. Field one contains two closed captioning streams (CC1 and CC2) and two text services streams (T1 and T2). Field two contains two additional close captioning streams (CC3 and CC4) as well as two additional text streams (T3 and T4). CC1 is most often used to carry verbatim English captions while CC3 is increasingly being used for Spanish-language captions and captions edited for young children. The primary purpose of a closed captioning signal is to provide a visual depiction of the information simultaneously being presented on the audio sub-channel of the television broadcast. The closed captioning signal can be decoded to produce a sequence of alphanumeric characters that form words and sentences, which are typically limited to white block letters within a box-like black background field. The content of these sentences corresponds to the dialog that is occurring in the television broadcast. Various closed captioning data rates are used, but the standard closed captioning rate is 480 bits per second which is formatted as 60 characters per second (8 bits per character).

Due to the remarkable success of closed captioning services in the analog broadcast realm, the FCC has also mandated digital television close captioning (DTVCC) compliance. For Advanced Television Systems Committee (ATSC) digital or high-definition programming, three streams are recommended to be encoded in the video: two backward-compatible Line 21 captions and a set of up to 63 additional caption streams encoded in CEA-708B format. On Jul. 31, 2000, the FCC issued a Report and Order (R&O) in ET Docket No. 99-254 regarding DTVCC. The R&O amended Part 15 of the FCC Rules, adopting technical standards for the display of closed captioning on digital television receivers. As of Jul. 1, 2002, the FCC also required DTV receiver manufactures to include closed captioning decoding functionality into all DTV devices.

Thus, since these closed captioning signals are virtually ubiquitous, this third category of broadcast monitoring relies on the closed captioning text data for classification and analysis of broadcast programs. For example, one known system extracts and decodes Line 21 of standard television broadcast signals in order to parse closed captioning information. The system compares the closed captioning characters to a known library of captions or keywords. When the system finds a match, it identifies the program and records an identification number, the station on which the program was broadcast, and the date and time of the broadcast. Another known system, which provides for broadcast presentation and editing, utilizes closed captioning information to locate items of interest. The system matches viewer-defined keywords against an extracted closed captioning text stream from a television broadcast signal. The corresponding segment of the broadcast that matches the viewer-defined search criteria may then be displayed, edited, or saved.

The above described media monitoring techniques do not provide thorough analysis of media coverage. For example, the closed captioning systems do not analyze sufficient references for accurate monitoring such as visual references, contextual references, and grammatical references.

Visual references are found in media that suggest or allude to a company, brand, product, or service via visual cues. For example, if product logos and company locations are used within a media segment, closed caption monitoring alone will not match these media segments with the corresponding monitoring search criteria or keywords.

Contextual references are found when reviewing an entire media segment in context; these references may yield additional information, such as key issues, consumer tendencies, or social trends. In addition, contextual references may include inflection or tonality of a broadcaster's voice, which often can indicate whether a media segment should be viewed as positive, negative, or neutral. The recordation of tonality and other contextual references yields a more comprehensive view of monitored media segments than closed captioning analysis alone.

Finally, since closed captioning often misspells words and captures phrases incorrectly, many sentences analyzed via closed captioning are unintelligible. Such errors can lead to entire segments being misclassified. Since most electronic media monitoring is based on keyword recognition, misspelled words and grammatical idioms that refer to critical mentions of a brand, company, product, or service would not be captured using traditional electronic broadcast monitoring.

Existing systems also tend to be inefficient, requiring purchase of complete media segments before these segments are available for display. Since electronic systems tend to misclassify media, segments of little or no relevance are often purchased without a complete understanding of what information the broadcast segment contains.

Thus, a clear need exists for an integrated method of monitoring all forms of disseminated media, including advertising, news, and editorial content, in a comprehensive and holistic manner. A new media monitoring method is also needed that strategically supplements traditional electronic monitoring techniques with human monitoring and reporting. Also needed is a method for viewing and previewing relevant media segments and images that match certain search criteria prior to purchase. In short, what is needed is a simple, unified media gathering, analysis, purchasing and delivery mechanism.

### SUMMARY OF THE INVENTION

The present invention is directed to a novel method of monitoring media, including advertising, news, and editorial content, across all media channels more effectively, and efficiently.

The present invention comprises an integrated method for monitoring, purchasing, and displaying all forms of disseminated media content. Disseminated media may include any form of information, including, but not limited to, broadcast news and editorial segments, newspaper and magazine articles, journal entries, advertisements, radio segments, billboards, etc. Disseminated media also explicitly includes consumer-generated or consumer-derived media, such as Internet discussion boards, groups, and forums, chat rooms, Internet newsgroups, web logs (“blogs”), personal websites, consumer ratings websites and forums, and any other public opinion, public consensus, or related information. Servers strategically positioned in key markets monitor, record, and encode all forms of disseminated media in real-time or near real-time. The captured media is then subject to both closed captioning analysis (if available) and human monitoring and reporting to ensure the highest level of media relevance. Users may then initiate an almost instantaneous preview of media matching a certain search criteria from a network location and purchase the media in a high-quality digital format, if desired.

The present invention thus comprises methods and systems for gathering and viewing media clips. The invention can scale so as to view segments of broadcast and other media from all major markets in near-real time via a flexible user interface. In general, the invention gathers media multiple locations and multiple sources. This media can then be stored, sorted, and searched according to various system and user criteria. A user can then log in to the system to preview, retrieve or purchase relevant media segments, reports that summarize segments, and analyses of such segments.

Thus, the invention has a number of advantageous features. For example, with distributed servers across all major markets, the current system is scalable. Further, by using closed captioning analysis in conjunction with human monitoring, the current system is comprehensive and accurate. Also, by using advanced video storage, compression, and streaming video, the system of the present invention is efficient and cost-effective for end users.

In general, the present invention may include servers strategically positioned in all major markets to capture broadcast data from all available sources. The storage of this data may be distributive, or, alternatively, the data can all be stored at one central location. The servers receive and record broadcast segments as aired from a variety of broadcast feeds. In one embodiment, the segments are then encoded or converted into a format for transmission to storage and processing devices via an IP network.

Second, the present invention may use various types of media monitoring. As described above, most of the prior art systems generally use only one type of electronic media monitoring. The system of the present invention may incorporate any number of methods of monitoring, including closed captioned analysis, human monitoring of video, speech to text analysis of radio and TV, Internet monitoring, OCR scanning, etc. Thus, for each segment of media, the method may employ multiple analyses to provide a thorough analysis of the particular media. For example, in a broadcast media environment, a combination of closed captioning analysis and human monitoring can be used. Closed captioning analysis can capture every segment of media where a certain word or phrase was uttered and human monitoring can be used to capture other references to the product and to ascertain whether a clip speaks about a product positively, negatively, or in a neutral manner.

In a preferred embodiment, the strategically placed servers capture and compress media from a variety of sources. The media is then sent via a high-bandwidth connection to facilities for analysis. The analysis is then performed according to user defined criteria. Reports are generated, which can be viewed by a user. Media clips will also be available for view and/or purchase by a user.

Indeed, one of the advantages of the invention is that it presents a user-friendly interface to each user, which may be web-based. From this interface, the user will have the ability to review reports, preview media segments, purchase media segments and organize presentations of media clips and reports. To enable this interface, segments may be encoded or converted into a streaming media format suitable for Internet transmission and immediately made available to subscribers. This way, users of the present invention may preview advertising and editorial coverage in near real-time from anywhere in the world via an Internet connection.

The reporting features of the present invention allows advertisers and the like to understand how their products or services are being received by the general public. For example, advertisers can determine whether editorials are generally positive, negative, or neutral with respect to discussions of a product or service. As another example, advertisers can evaluate and predict the estimated audience that might view a commercial about a particular product. As yet another example, advertisers can monitor Internet chat rooms and blogs related to discussions about products or services. The invention provides a user interface through which all of this information can be organized, viewed and downloaded quickly and easily. In addition, reports can be generated and shared which summarize this information.

Therefore, it is an object of the present invention to provide a method of monitoring media so that results matching search criteria are more relevant and yield more information.

Another object of the present invention is to provide an automatic method of classifying media content utilizing closed captioning information in addition to human monitoring and reporting.

It is another object of the present invention to provide a method of viewing and previewing and displaying digital media segments over a network before purchase.

Another object of the present invention is to provide a novel method for purchasing high-quality digital media segments over a network after preview.

Still another object of the present invention is to provide reports about media segments to users so that users can understand how a product is being received by the market.

Yet another object of the present invention is to provide a web-based interface through which a user can preview media segments, organize media segments, purchase media segments and organize and purchase reports which elucidate how a product or service is being received by the public.

Another object of the present invention is to help businesses understand the effectiveness of their advertising by presenting comprehensive information about market share, the total size of the viewing audience and other audience information.

Still another object of the present invention is to provide tonality information about how the media perceives and reports on a business' products and/or services.

Yet another object of the present invention is to save users time and money by providing a method to preview media segments.

Another object of the present invention is to present a comprehensive summary and analysis of each media segment to a user.

Still yet another object of the present invention is to provide a mechanism for recording and searching broadcast media from all major television markets.

Other objects, features, and characteristics of the present invention, as well as the methods of operation and functions of the related elements of the structure, and the combination of parts and economies of manufacture, will become more apparent upon consideration of the following detailed description with reference to the accompanying drawings.

### BRIEF DESCRIPTION OF THE DRAWINGS

A further understanding of the present invention can be obtained by reference to a preferred embodiment and various alternative embodiments related thereto as set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1 is a schematic block diagram of the architecture used to implement the integrated media intelligence method in accordance with the preferred embodiment of the present invention;

FIG. 2 is a schematic diagram depicting the various forms of media coverage which may be monitored by the comprehensive monitoring method in accordance with the preferred embodiment of the present invention;

FIG. 3 is a flow diagram of a routine for viewing and displaying media hit lists and reports in accordance with one embodiment of the present invention;

FIG. 4 depicts a flow diagram of a routine for previewing and purchasing digital media segments in accordance with one embodiment of the present invention;

FIG. 5 depicts a sample web-based user interface which allows a user to preview digital media segments and to review analyses of various media hits in accordance with one embodiment of the present invention; and,

FIG. 6 is a table illustrating the types of available displays of monitored media segments in accordance with one embodiment of the present invention.

### DETAILED DESCRIPTION OF THE PREFERRED EMBODIMENTS

As required, a detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for the purposes of disclosure and to provide a basis for the claims herein, which define the scope of the present invention. The following presents a detailed description of a preferred embodiment (as well as some alternative embodiments) of the present invention.

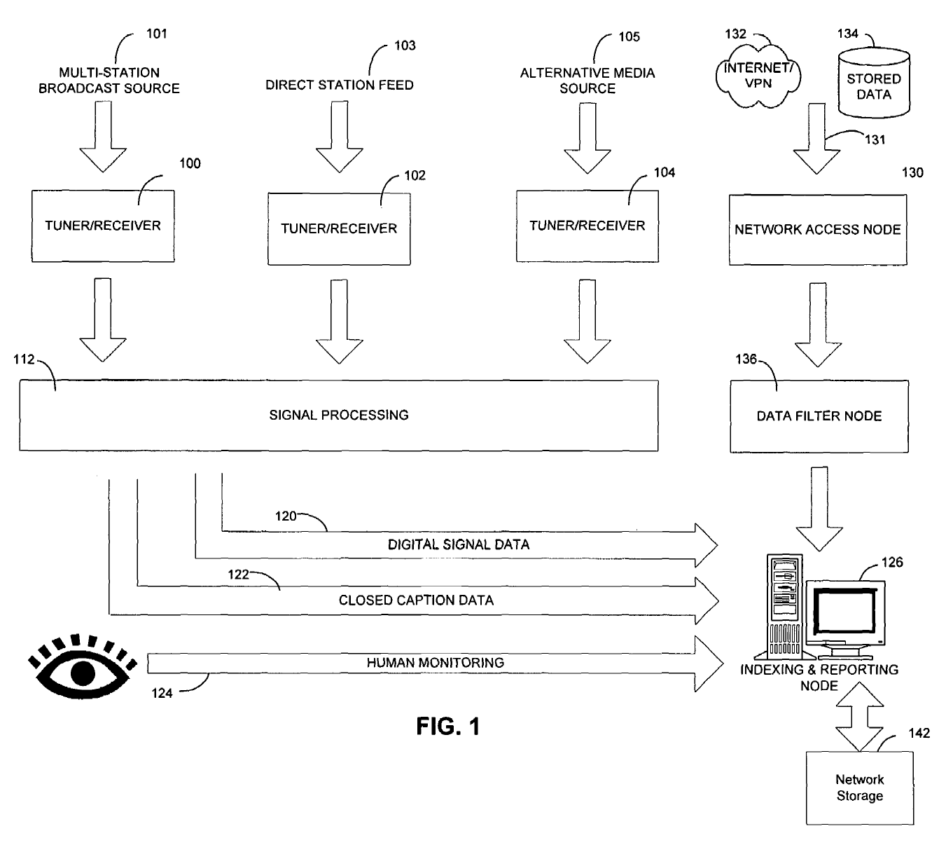

Referring to the drawings wherein like numerals indicate like elements throughout, in FIG. 1 is a schematic block diagram of the integrated media monitoring method in accordance with one embodiment of the present invention. Tuner/receiver 100 receives analog or digital signals from external sources 101; For example, tuner/receiver 100 may receive a multi-station broadcast coaxial transmission from a cable television network. Alternatively, tuner/receiver 100 may receive a multi-station broadcast source from an atmospheric transmission, including satellite, microwave, UHF, or any other wireless or facilities-based signal transmission mechanism. The transmission itself may comprise DTV, DVB, or analog signals, as well as any other broadcast transmission signal used for broadcast media. Broadcast media comprises all forms of disseminated media, including, but not limited to, broadcast news and editorial segments, newspaper and magazine articles, advertisements, billboards, etc. Broadcast media also explicitly includes consumer-generated or consumer-derived media, such as Internet discussion boards, groups, and forums, chat rooms, Internet newsgroups, web logs (blogs), personal websites, consumer ratings websites and forums, and any other public opinion, public consensus, or related information.

Similarly, tuner/receiver 102 may receive direct single-station feed 103 via any transmission mechanism, including high speed optical fiber and satellite links. Tuner/receiver 104 may receive various forms of mixed or alternative broadcast media 105, including satellite radio media, etc. As is common in the art, tuner/receivers 100, 102, and 104 may demodulate the signal, if required, and output the demodulated signal to signal processing node 112. Signal processing node 112 may comprise a closed captioning decoder for extracting a closed caption stream of textual data from a broadcast signal, if one exists. Typically, the closed captioning decoder extracts information from Line 21 of the vertical blanking interval of the broadcast signal and converts this information into a text stream, although other forms of closed captioning decoding may also be utilized without departing from the spirit of the present invention. Signal processing node 112 outputs digital signal stream 120 and closed caption stream 122. These two streams, along with human monitoring stream 124 are received by indexing and reporting node 126. Human monitoring stream 124 supplements the closed captioning data in order to provide more comprehensive reports and closer media content matches. For example, human monitors may analyze speaker tonality and other factors in order to classify each media segment as positive, negative, or neutral. Human monitors may also document grammatical, contextual, and visual-only references that closed caption monitoring may miss and record various other human-perceivable attributes of the media segment.

Signal processing node 112 may also comprise other processing modules to extract information from non-broadcast sources of media. For example, signal processing node 112 may comprise speech to text processors or software to extract text uttered on the radio. As another example, signal processing node 112 may comprise OCR software to extract information from print sources of media, as discussed below.

The system of the present invention can also receive data from sources such as the Internet, other third parties, print media, etc. In the embodiment depicted in FIG. 1, this data is received by network access node 130 from Internet VPN 132 and stored data 134. Network access node 130 may also access a broad array of external data. Stored data 134 may be maintained by a media provider, the monitoring service provider, or a third-party. For example, stored data 134 may comprise market or product data, consumer satisfaction surveys, and other stored analyses and product information. Stored data 134 may additionally comprise subscriber search or keyword criteria and various forms of media comparison data, including closed captioning associations. Internet/VPN 132 may be a source of continuous Internet media, such as web logs (blogs), podcasts, forums, chat rooms, newsgroups, electronic bulletin boards, etc., which all may be monitored and/or recorded by the media monitoring method of the present invention.

In the preferred embodiment, network access node 130 comprises high-speed fiber optic OC-3 data link 131 to Internet/VPN 132 and stored data 134, but any network access mechanism exhibiting any data transfer rate may be utilized, as appropriate. OC-3 data link 131 is preferred because it allows for faster transfer of data from Internet VPN 132 and stored data 134. Data received via network access node 130 is screened by data filter node 136. Data filter node 136 may comprise a packet filter, firewall, or other network filtering device that processes incoming network data from the network access stream. Data filter node 136 may comprise advanced filtering and media recognition functions, such as automated media and broadcast designation routines. Data filter node 136 and network access node 130 may optionally be integrated within indexing and reporting node 126.

Indexing and reporting node 126 analyzes all incoming data streams for relevant media. Indexing and reporting node 126 matches this media to a valid user system-defined search criteria. Indexing and reporting node 126 may additionally utilize data from various other sources. Relevant media may be indexed, catalogued, or stored within indexing and reporting node 126 or network storage 142. Due to the potentially voluminous size of the captured media, well-known video and data compression schemes are typically implemented. Indexing and reporting node 126 may also generate various related reports and analyses pertaining to the captured media, including editorial and advertising chronologies and histories, market share forecasts, impression counts, tonality charts, estimated ad value equivalency, media coverage maps, as well as full text summaries and abstracts of the captured media.

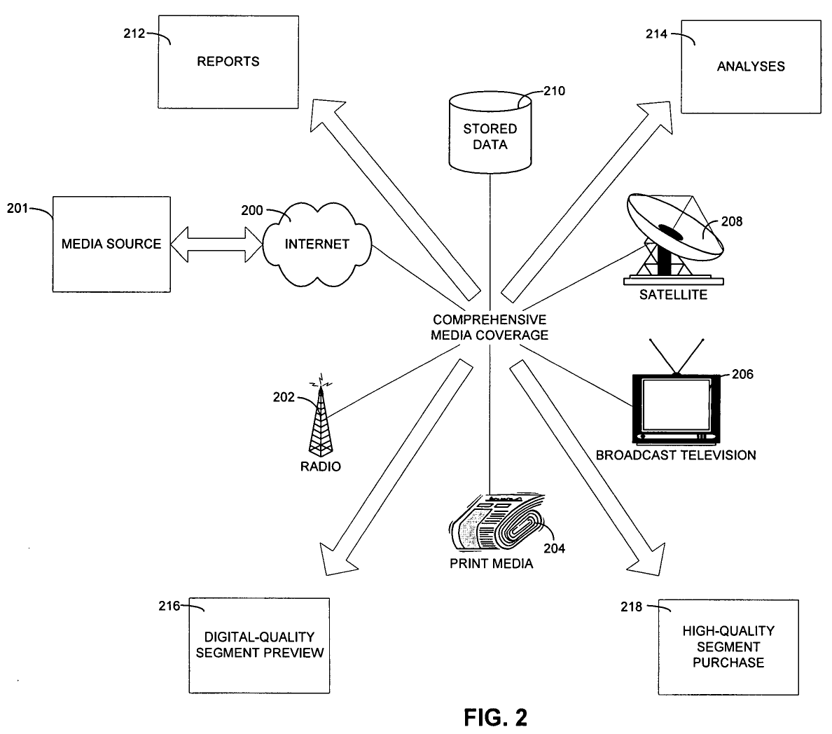

Now referring to FIG. 2, some of the various forms of media that may be monitored utilizing the present invention are shown. It should be noted that the present invention is not limited to monitoring these types of media. Instead they are depicted as exemplary monitoring sources only. The present invention comprises a comprehensive media monitoring solution for monitoring and analyzing all forms of disseminated, published, or broadcast media. Electronic media, often in the form of Internet and private company intranet media, is accessed via Internet 200. As is common in the art, confidential or proprietary media may be accessed securely via Internet 200 through the use of such standards as Secure Sockets Layer (SSL), Transport Layer Security (TLS), HTTPS, secure FTP, or any other encrypted or otherwise protected communication. In addition, a Virtual Private Network (VPN) may be utilized to create secure tunnel connections between devices communicating over a public network (such as Internet 200). Internet 200 also allows access to a broad array of other electronic media, including Internet discussion boards, groups, and forums, chat rooms, Internet television (IPTV), Internet newsgroups, web logs (blogs), personal websites, consumer ratings websites and forums, and any other public opinion, public consensus, or related information (collectively depicted as Internet media source 201). All of the foregoing electronic media may be searched and analyzed for specific user-defined or system-defined keywords or phrases and recorded in accordance with the present invention.

The present invention is also capable of monitoring media from radio 202, print media 204, broadcast media 206, satellite 208 and other sources of data such as stored data 210. Radio transmissions include AM band radio, FM band radio, short wave radio, single sideband (SS) radio, continuous wave (CW) radio, radioteletype (RTTY), packet radio, and any other type of radio transmission. The received radio transmissions are demodulated (if required) and analyzed. Speech-to-text engines or voice recognition software may be utilized to produce searchable text. of radio segments. This searchable text stream allows for user-defined or system-defined keyword matching. Radio segments matching a specific search criteria are recorded for later access by subscribers of the present invention.

The present invention is also compatible with print media 204. Newspapers, magazines, journals, consumer reports, billboards, and any other printed matter may be parsed and searched for applicable user-defined or system-defined keywords. Searching of print media typically involves the conversion of print media 204 into electronic form. As is common in the art, various scanning techniques may be utilized to convert print media 204 into electronic form. These conversion routines may include optical character recognition (OCR), digital image scanning, various pattern recognition engines, or any other optical or digital recognition. Print media 204 may also comprise a printed feature, such as a barcode, watermark, or hologram, to assist in the electronic conversion, media identification or recognition process. For example, to simplify media identification, a barcode embedded or printed within printed media 204 may allow automatic access to a database of stored information related to printed media 204. Alternatively, the barcode or other printed feature associated with printed media 204 may contain complete identification data in encoded form.

Media intelligence may also be derived from broadcast television 206. Broadcast television 206 includes any single-source or multi-station analog or digital television feed, including, but not limited to, UHF, VHF, DTV, HDTV, and cable television services. Closed captioning data obtained from Line 21 of the vertical blanking interval (or any other closed captioning format or service) may be utilized to classify broadcast television media segments. For example, closed captioning streams may be searched for a relevant keyword search criterion. Segments matching particular user-defined or system-defined criteria may then be indexed, recorded, or further analyzed.

Satellite data, including satellite radio data and direct-to-home (DTH) satellite television data, can also be monitored from a source such as satellite 208. Similar to broadcast television 206 and radio 202, media transmission via satellite 208 may be electronically analyzed via closed captioning data or speech-to-text engines, as appropriate.

Disseminated media compatible with the present invention may also include stored data 210. Stored data 210 may comprise, for example, market or product data, consumer satisfaction surveys, and other stored analyses and product information. This data may reside in databases, files, or any other computer readable medium. Stored data 210 may additionally comprise product or market sector analyses, product or service distribution tables, or any other stored information related to a product, service, brand, or company.

The present invention thus provides comprehensive media coverage across all forms of disseminated media, including Internet 200, radio 202, print media 204, broadcast television 206, satellite 208, and stored data 210. From these media streams, the present invention creates high-quality media reports 212 and analyses 214. Users are able to search for relevant media—including news, editorial, and advertising—by numerous search criteria, including region, date range, content, ad value equivalency, and estimated audience. Media reports 212 may include an overview of all media coverage matching a certain criteria with links to the actual media content. For example, a daily report on a company's total media coverage (or a competitor's media coverage) for the current day can be accessed via media reports 212. Media reports 212 may also comprise links to full-text print stories, broadcast video and radio clips, scanned graphics and advertisements, web coverage, and transcripts. Media reports 212 also support media coverage tracking by time period, such as monthly clipping reports, etc. Additionally, media reports 212 may detail levels of media coverage in different media segments and various geographic regions, as requested by a user of the present invention.

Analysis node 214 allows users to search, filter, track, chart, and compile data related to media segments. Human monitors may additionally tag each media segment with keyword descriptors relating to tone, market, content, author, etc. By utilizing these descriptors, analysis node 214 permits access to media comparison charts, tables, and graphs. These charts, tables, and graphs measure and compare various user-defined or system-defined criteria. For example, impression count, tonality, and ad value equivalency (AVE) can be used to track, chart, and analyze media coverage over time or by market region or sector. In addition, coverage summary tables, tracking charts, and graphs can be generated and displayed. Analysis node 214 may also generate reports on selected competitor media activity. These competitor reports may be tracked by author, publication, media segment, etc. Analysis node 214 also provides one-click access to media summaries and recent media activity data.

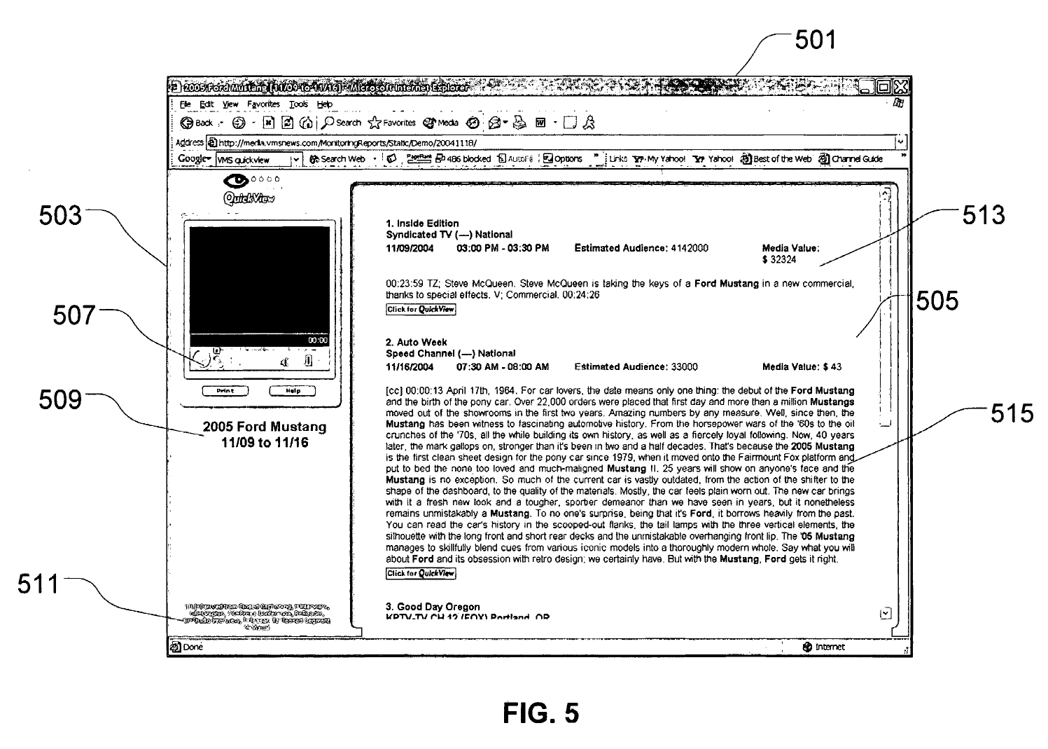

Digital-quality segment preview 216 allows for near real-time viewing of media clips (e.g., broadcast news clips) via an interface. A web-based interface connects to an Internet server for streaming of digital-quality video and audio. The streaming media may be presented within a standard web browser as a Windows Media, RealTime (Real Video/Real Audio), QuickTime, MPEG, Flash, or similar media clip. An example of a web-based user interface is shown and discussed in more detail with respect to FIG. 5, infra. News monitors and editors may additionally view the monitored media clips and produce cogent summaries and synopses. These summaries and synopses may be presented to a user in a reading pane before the steaming media clip is previewed. In this way, only relevant media clips are previewed, saving valuable bandwidth, time and user costs. Abstracts of media segments are also available. The summary pane may additionally include pertinent information about the media clip about to be previewed, including date, time, and station(s) aired, title, length, author, estimated audience, ad value equivalency, tonality, etc.

Previewing of digital-quality segments is made possible by servers strategically positioned in key markets throughout the media monitoring coverage area. These servers receive and record broadcast segments as aired from a variety of broadcast feeds. The segments are encoded or converted into a streaming media format suitable for Internet transmission and immediately made available to subscribers. This way, users of the present invention may preview advertising and editorial coverage in near real-time from anywhere in the world via an Internet connection.

Digital-quality segment preview 216 may also include thumbnail storyboard displays. In the preferred embodiment, these unique displays are comprised of sampled frames of a broadcast editorial, news, or advertising segment disposed side-by-side in a tabular layout. In a preferred embodiment, human monitors ensure that only the most critical frames are displayed. However, any convenient layout and frame sampling scheme may be utilized. The storyboards may include graphic shot-by-shot post-production frame thumbnails with a corresponding, full-text transcript for each frame displayed beneath each still frame. Storyboards are a convenient way to efficiently deliver and analyze subtle details of media segments. Frames for storyboard production may be sampled electronically (e.g., every 10 frames) or sampled for key frames chosen to illustrate the essence of the segment. Storyboard sample rates and the actual frames sampled may be changed at any time by a requesting user, the system, or a third party. Storyboards may be presented electronically (e.g., in Adobe PDF or other convenient document format, within a webpage, or via email as an attachment or inline graphic). Alternatively, color printed storyboards may be delivered via postal mail to a requesting user.

Still referring to FIG. 2, media clips may optionally be purchased via high-quality segment purchase node 218. After previewing relevant matches via digital-quality segment preview 216, an option may be provided for high-quality media purchase. The media available for purchase may be encoded at a higher quality (e.g., higher frame rate, increased color depth or resolution, higher-quality audio, or larger video size) than the media available for preview. (Preferably, preview media is of a lower quality so that it can be quickly streamed to a user, even if the requesting user has a limited bandwidth connection to the system). In addition, purchased media may be viewed and downloaded to disk, whereas previewed media (which is streamed to a user) is generally not available for download. High-quality segment purchase node 218 may verify or validate a user's account for good-standing, available credit, etc. before delivering a high-quality media clip for purchase. In the preferred embodiment, the high-quality media clip is delivered over the Internet as a secure HTTP or FTP download. However, high-quality video may be purchased and delivered in various other ways, including via email, instant message transfer, postal mail, etc. In lieu of validating an account, high-quality segment purchase node 218 may prompt the user for purchasing information on a per-purchase basis. Purchasing may also be handled by a third party (e.g., a credit card company, PayPal, etc.).

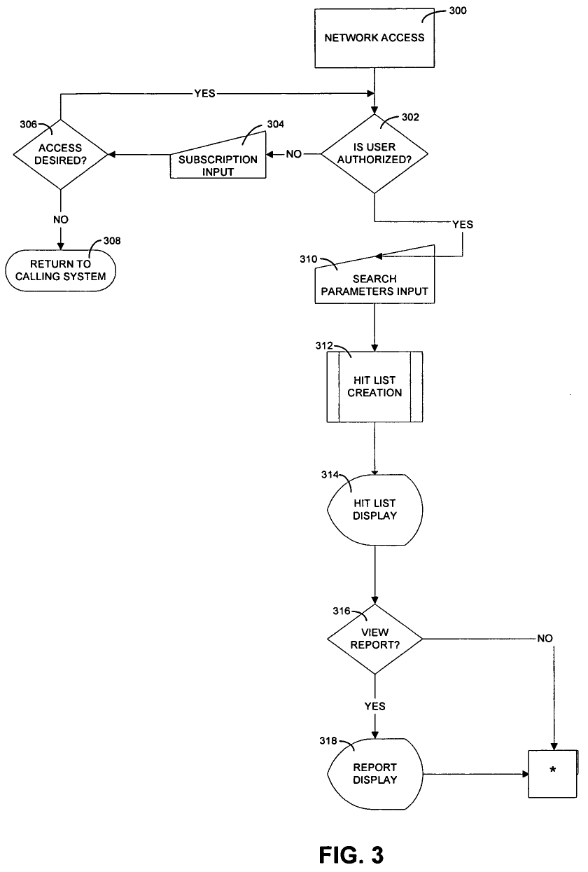

Now referring to FIG. 3, a flow diagram of a routine for viewing and displaying media hit lists and reports is shown. The first step in the routine is accessing the network at network access stage 300. This typically involves establishing a connection to the system of the present invention via a public network connection (e.g., the Internet), or via private network access (e.g., via VPN). For additional security, this connection may be encrypted or secure. A user accessing the media monitoring service is authorized at authorization stage 302. This step may comprise the submission of a username and password combination or any other conditional access technique common in the art. Users may also establish “guest” accounts to allow others limited access to the system. One application of a guest account would be if an advertising company wanted to show a customer how effective an advertising campaign is. The advertising company would establish a guest account for the customer to allow the customer to, e.g., view reports created by the advertiser.

If the user is not presently authorized, and is not a guest, the user may subscribe to the service at subscription input 304. Billing information, such as a credit card number and/or account information may be validated and the user may create an account to access the service. After subscription input 304 is submitted, the present invention may determine if access to the service is now desired at access desired stage 306. If access to the service is not desired, the system returned the user to the calling system or web page at return stage 308. If access desired stage 306 determines that access is now desired to the service, the user is returned to authorization stage 302 so that the user may login to the service.

After a user successfully logs into the system, the user can access hit results, including media segments, comments about those media segments, reports, graphs, charts etc. Alternatively, a user can also create or modify search criteria used by the system to generate hit lists. If a user wishes to create or modify a hit list, the first step is completed at search parameters input 310. At this input, the user may enter criteria for media searching. For example, a user might search by type of media, content, author, date and time, station, tone, market, impression count, ad value equivalency, or estimated viewing audience, etc. The user may specify various filter criteria at search parameters input 310. Filter criteria may be system-defined or user-defined and may further limit a media search. For example, a user may establish a filter to exclude all print media. Logical connectors (e.g., AND, OR, LESS THAN, GREATER THAN, EQUAL TO, STARTS WITH, CONTAINS, etc.) may be used to create complex filter strings, or logical filter expressions. Different search terms and parameters can be used for different types of media. Available search and filter criteria may be added, deleted, or edited at any time by the system, the user, or a third-party. In addition, search criteria may be partially system-derived. For example, monitoring threads may be established prior to or during authorization stage 302. These threads may limit or define media availability on a per-user basis and may act as media boundaries. These threads may be limited to a certain type of media content, a certain product, service, market, or industry, or any other convenient criteria. In this manner, subscribers can be restricted only to monitored media channels to which a user has subscribed.

After a desired search criteria is entered at search parameters input 310, the present invention searches and develops a hit list of matching media at hit list creation 312. Hit list creation 312 may consult indexed databases, stored information, or other servers to perform the media search. This hit list is then displayed to a user at hit list display 314. Certain media hits may be hidden from display, depending on the authorization level or account status of the user. For example, the system may not display media types that the user has not subscribed to or paid the service to monitor. If a guest has logged in, that guest may be similarly limited to a certain subset of available media segments.

From the available hit list display, a user may elect to view a media report at view report stage 316. If a media report is desired, report display 318 displays the desired report (e.g., directly in the user's browser). Report display 318 may comprise links to full-text print stories, broadcast video and radio clips, graphics, web coverage, and transcripts. Additionally, report display 318 may detail levels of media coverage in different media segments and various geographic regions, as requested by a user of the present invention.

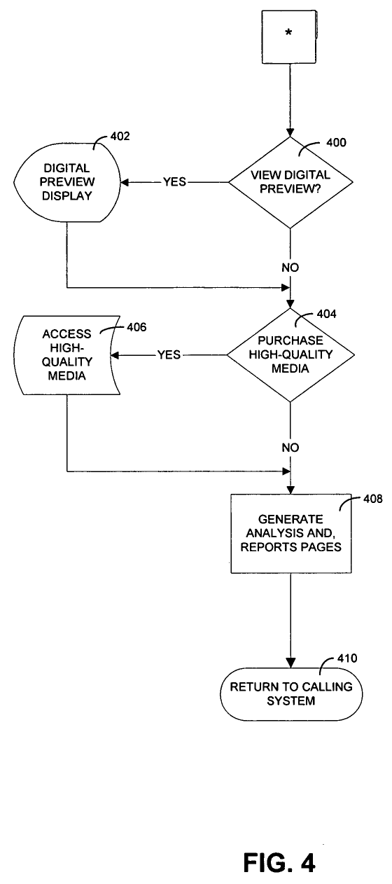

FIG. 4 is a continuation of FIG. 3 as depicted by the “*” node of each figure. As shown in FIG. 4, a user also has the option to preview media at digital preview stage 400. If a media preview is desired, the user is presented with digital preview display 402. This display may comprise a streaming segment of all or a part of a media clip of interest. For example, a Windows Media, RealTime (Real Video/Real Audio), QuickTime, MPEG, Flash, or similar media clip may be streamed directly within the user's browser. As described above, it is preferred that the video to be previewed is of limited quality for at least two reasons. First, it encourages users to purchase the higher quality version of the media. Second, it enables previewed segments to stream quickly to users, even if the user only has a limited bandwidth connection. The user may also purchase a high-quality version of the selected media segment of interest at purchase stage 404. If the user's account is presently in good standing and the user wishes to purchase a media segment, the user is delivered the segment electronically over the network at media access 406. If the user's preferences indicate that a physical copy of the high-quality media is desired, then the purchased media may be delivered by postal mail. Media access 406 may connect to a network storage location in order to deliver the high-quality media segment to the requesting user. Such connection may be secure to prevent fraud, theft, or unauthorized access.

After the purchase of the media segment, the analysis and reports pages are regenerated at generate page stage 408. The user may then refine the search criteria or select another media segment of interest from the previous hit list. At return stage 410, the user is returned to the calling system or web page.

Referring next to FIG. 5, depicted is a sample web-based user interface which allows a user to preview digital media segments and to review analyses of various media hits. In this example, the user is presented with web-based interface 501, which is accessible via any standard web-browser over any standard Internet connection. Although interface 501 can be organized or presented in a variety of fashions, in this example, it is divided into preview pane 503 and information pane 505. Preview pane 503 comprises video player 507, information field 509, and caption 511. Preview pane 503 enables a user to preview media clips before optionally purchasing these clips, downloading these clips, or sharing these clips with other users. A user selects a clip to preview, and video player 507 enables the user to interactively preview this clip. In a preferred embodiment, the video for that clip is streamed in a compressed format to (1) reduce necessary bandwidth and (2) decrease the time a user has to wait before receiving the clip. Information field 509 and caption 511 provide further information about the clip being viewed or the user defined search criteria which led to the clip being found by the system.

Interface 501 also comprises information pane 505, which gives user desired details about relevant media hits. In the example of FIG. 5, details for two hits, i.e., Inside Edition hit 513, and Auto Week hit 515, are shown. In this example, the user created search parameters so that the system would generate a hit list comprising all media clips that contained references to a “Ford Mustang.” Each hit describes when and how the reference occurred, and provides other information including the name of the television program, the date, the time, the audience, and a value to the company.

In the example of FIG. 5, the first hit, Inside Edition hit 513, was a visual reference to a Ford Mustang. Importantly, this hit would be missed by traditional systems which merely analyze closed captioning data. Here, instead the hit was generated by a human monitor instructed to search according to the user defined parameters. Auto Week 515, on the other hand, was a hit generated by analysis of closed captioning data. Both hits 513 and 515 are clickable, enabling a user to preview the hits and if desired purchase the video associated with each hit.

For all human generated hits, such as Inside Edition hit 513, a tonality may be associated with the hit. For example, the tonality may be positive, negative, or neutral. In one embodiment, a positive tonality can be indicated by an icon, such as a green icon, a negative tonality can be indicated by another icon such as a red icon, and a neutral tonality can be indicated by a third icon, such as a yellow icon.

Thus, the system of the present invention enables a user to understand how a product is being viewed by the general public. Interface 501 enables a user to quickly browse hits to effectively gain this understanding. While FIG. 5 is an example of the present system providing broadcast media hits, it is to be understood that the invention can provide similar information for all types of media such as print, Internet, radio, satellite, etc.

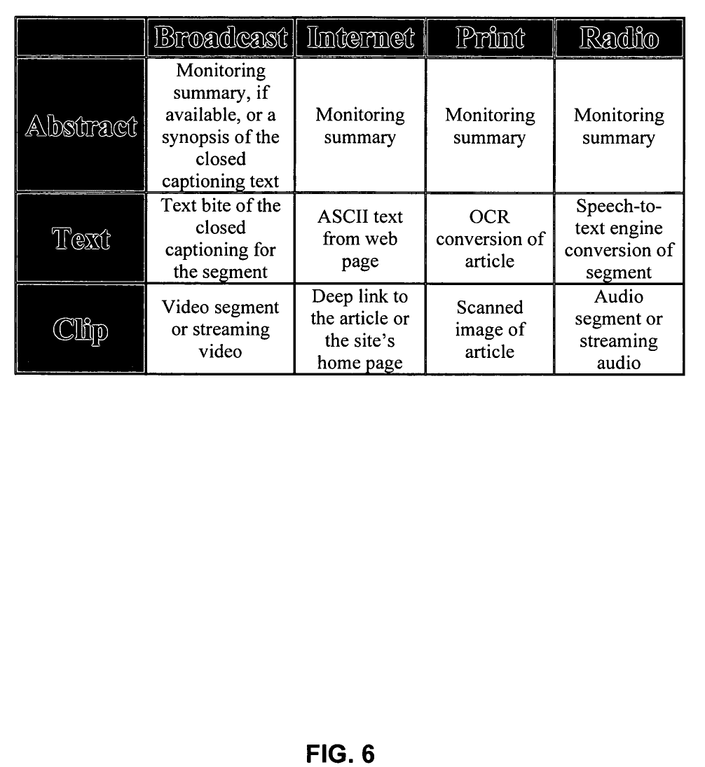

Now referring to FIG. 6, a table is shown illustrating a sampling of the available media displays in accordance with one embodiment of the present invention. Three main displays are offered to a user of the present invention for each media segment monitored. Although three forms of display—abstracts, texts, and clips—are envisioned, other forms of media display may also be utilized in accordance with the present invention. Abstract displays across all four main media sectors—broadcast, Internet, print, and radio—comprise monitoring summaries, which are typically created and reviewed manually by editorial staff members to ensure a high degree of accuracy and relevance. These monitoring summaries comprise cogent synopses of monitored media for quick review and may additionally include attributes pertaining to the media segment, such as title, author, date, length, station, publication, impression count, and ad value equivalence. Monitoring summaries may also include tonality indications and other staff-derived classifications. If monitoring summaries are not available for broadcast media, then a synopsis of the closed captioning script is provided as an alternative to the monitoring summary.

Text displays comprise full text versions of the monitored media segment. For broadcast media, the text display comprises the text of the closed captioning data for the media segment. Alternatively, speech to text engines may be used to generate this text. If closed captioning is used, the text bite may be the complete closed captioning stream, or any formatted or abridged derivative thereof. The text display for media derived from the Internet is typically the ASCII text from the web page itself. This text may be derived from the source HTML code of the Internet media, a data feed service (e.g., RSS, XML data feed), or any other Internet text or news delivery routine. For print media, text displays typically comprise the OCR conversion of the print article. Similarly, radio segments may also be converted to text form via a speech-to-text engine, speech recognition module, or other like forms of speech conversion routines.

Still referring to FIG. 6, clip displays may comprise segments of video or audio, or streaming video or audio for broadcast and radio media. Video and audio segments are actual media segments as aired encoded in Windows Media, QuickTime, Real Video, or other format suitable for network transmission. As is common in the art, these segments may be played or streamed directly to a web browser or media application. The segments may be encoded or compressed as necessary. Clip displays for Internet media comprise a deep hyperlink where the article can be found (or the hosting site's home page, if the deep link is unavailable or access is restricted). This link affords a user simple, one-click access to the actual monitored Internet media (or a cache or copy thereof). Finally, for print media, the clip display comprises a scanned image of the print article or advertisement. This scanned image may comprise high-resolution graphics as well as text and other embedded information objects.

From the foregoing description of the preferred embodiments, which embodiments have been set forth in considerable detail for the purpose of making a complete disclosure of the present invention, it can be seen that the present invention comprises a method for integrated media monitoring, purchase, and display over a network. It will be appreciated by those skilled in the art that changes could be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

What is claimed is:

1. A method for integrated media monitoring, purchase, and display over a network, said method comprising:
digitally recording and encoding broadcast media segments;
generating a summary of each said media segment;
receiving an electronic request for at least one said media segment from a user over a network, said electronic request comprising user-defined media search criteria;
creating a list of said media segments matching said search criteria;
delivering a preview of said media segment over said network; and
delivering at least one said summary to said user over said network.

2. The method of claim 1 further comprising a purchasing means to enable said user to purchase at least one said media segment.

3. The method of claim 2 wherein said purchased media segment is of a higher quality than said preview.

4. The method of claim 1, further comprising a downloading means to enable said user to download a said media segment.

5. The method of claim 1 wherein said network comprises the Internet.

6. The method of claim 1 wherein said summary is generated electronically from closed captioning data associated with said media segment.

7. The method of claim 1 wherein said summary is generated by human monitors.

8. The method of claim 7 wherein said summary comprises a tonality indicator.

9. The method of claim 8 wherein said tonality indicator is positive, negative, neutral or a combination thereof on a scale.

10. The method of claim 9 wherein said positive tonality indicator comprises a green icon, said negative tonality indicator comprises a red icon, and said neutral tonality indicator comprises a yellow icon.

11. The method of claim 1 wherein said media segments are derived from the group consisting of radio, television, print, satellite, and the Internet.

12. The method of claim 1 wherein said electronic request is an HTTP request.

13. The method of claim 1 wherein said user-defined search criteria are selected from the group consisting of content keywords, title, author, distribution, date, publication name, media type, tonality, ad value equivalency, impression count, media relevance, and circulation.

14. The method of claim 1 wherein said preview is delivered in a streaming format.

15. The method of claim 1 wherein said request comprises a database query.

16. The method of claim 1 wherein said preview is delivered in Windows Media format, QuickTime format, or RealTime format.

17. The method of claim 1 wherein said preview is delivered in a compressed format.

18. An integrated method for monitoring broadcast media using closed captioning data, the method comprising:
receiving at least one broadcast media station signal;
demodulating said broadcast signal;
processing said signal to extract a closed caption data stream and a digital station stream;
recording said digital station stream;
parsing said closed caption data stream for at least one search keyword;
generating a text summary of said digital station stream, said summary comprising a text synopsis and a tonality indicator; and
streaming said digital station stream to a requesting user over a network.

19. The method of claim 18 wherein said network comprises the Internet.

20. The method of claim 18 wherein said tonality indicator is positive, negative, neutral or a combination thereof on a scale.

21. The method of claim 20 wherein said positive tonality indicator comprises a green icon, said negative tonality indicator comprises a red icon, and said neutral tonality indicator comprises a yellow icon.

22. The method of claim 18 wherein said media signal is derived from the group comprising radio, television, print, satellite, and Internet transmissions.

23. A method for digitally previewing broadcast media segments over a network, the method comprising the steps of:
displaying a text summary of a recorded broadcast media segment;
generating an electronic request for at least one digital media file associated with said summary;
accessing a storage device containing said digital media file; and,
streaming said media file over said network.

24. The method of claim 23 wherein said network comprises the Internet.

25. The method of claim 23 wherein said text summary is generated electronically from closed captioning data associated with said media segment.

26. The method of claim 25 wherein said text summary is supplemented by a human monitor.

27. The method of claim 23 wherein said text summary is generated by a human monitor.
